(19) United States
(12) Patent Application Publication
(10) Pub. No.: US 2025/0218710 A1
(43) Pub. Date: Jul. 3, 2025

(54) LOAD REGULATION DEVICE AND LOAD REGULATION SYSTEM

(71) Applicant: Chengli LI, Suzhou (CN)

(72) Inventors: Wensen CHEN, Suzhou (CN); Lingwei SHEN, Suzhou (CN)

(73) Assignee: Chengli LI, Suzhou (CN)

(21) Appl. No.: 18/955,076

(22) Filed: Nov. 21, 2024

(30) Foreign Application Priority Data
Dec. 29, 2023 (CN) 202311871621.2

(51) Int. Cl. H01H 19/14; H01H 19/04

(52) U.S. Cl. CPC H01H 19/14; H01H 19/04

(57) ABSTRACT

A load control device for regulating an electrical load includes: a support component including a connection portion; a knob frame including a gripping portion and an elastic portion, the gripping portion at least partially surrounding the support component and configured to drive the knob frame to rotate in response to a rotational force acting thereon, the elastic portion configured to move toward the connecting portion in response to the knob frame moving in a first direction, thereby undergoing elastic deformation; a first circuit board component; a switch trigger component; a switch component coupled to the first circuit board component, for controlling the load in response to triggering and releasing the triggering from the switch trigger component; and an adjustment component coupled to the first circuit board component, for adjusting the load in response to the rotation of the knob frame. The load control device simultaneously realizes rotation and pressing functions of the knob frame. A system including the load control device is also disclosed.

### BACKGROUND OF THE INVENTION

The present invention relates to the field of electrical load regulation, and more specifically, to an electrical load regulation device and system.

Load control devices are used to adjust and control electrical load. For example, a knob assembly on a knob dimmer is an exemplary load control device for lights. By turning the knob assembly on the knob dimmer, the luminous flux of the lighting load may be changed and the illumination level may be adjusted. For another example, the knob assembly on a fan is another exemplary load control device. By rotating the knob assembly, the wind speed, wind mode, etc. of the fan may be adjusted. However, most of such knob assemblies on the market currently only have a rotation function, but no push switch function. Therefore, there is an urgent need for a knob assembly that may realize both rotation and push functions, so as to better achieve the adjustment and control of the load.

### SUMMARY OF THE INVENTION

In order to solve one or more of the above problems existing in the prior art, various embodiments of the present invention provide an improved load regulation device and a load regulation system including the load regulation device.

In one aspect, the present invention provides a load control device for regulating an electrical load, which includes: a support component, including a connection portion; a knob frame, including a gripping portion and an elastic portion, wherein the gripping portion at least partially surrounds the support component and is configured to rotate in response to a rotational force acting thereon thereby driving the knob frame to rotate, and wherein the elastic portion is configured to move toward the connecting portion in response to the knob frame moving toward a first direction, thereby undergoing elastic deformation; a first circuit board component; a switch trigger component; a switch component, coupled to the first circuit board component, configured to control the electrical load in response to triggering and releasing triggering by the switch trigger component; and an adjustment component, coupled to the first circuit board component, configured to adjust the electrical load in response to the rotation of the knob frame; wherein the knob frame is configured to move toward the first direction in response to a first force acting on it, to drive the switch trigger component to trigger the switch component; and in response to a second force acting on it, to move toward a second direction opposite to the first direction under action of the elastic portion moving away from the connection portion due to recovery from elastic deformation, whereby the switch trigger component releases the triggering of the switch component.

In some embodiments, the knob frame further includes a snap-fit portion, and the support component further includes a corresponding snap-fit portion, and wherein the snap-fit portion cooperates with the corresponding snap-fit portion to prevent the knob frame from falling off the support component during assembly of the knob frame to the support component.

In some embodiments, when the knob frame moves toward the first direction, the snap-fit portion moves away from the corresponding snap-fit portion, and when the knob frame moves toward the second direction, the snap-fit portion moves toward the corresponding snap-fit portion to engage with the corresponding snap-fit portion.

In some embodiments, the snap-fit portion is formed on an inner wall of the gripping portion, and the corresponding snap-fit portion is formed on an edge of the connection portion.

In some embodiments, the snap-fit portion includes a plurality of claws extending inward from the inner wall of the gripping portion, wherein the plurality of claws are circumferentially distributed at equal intervals on the inner wall of the gripping portion.

In some embodiments, the corresponding snap-fit portion includes a step portion formed at an edge of the connecting portion.

In some embodiments, when the first force is applied to the edge of the knob frame, at least one of the plurality of claws clamps the step portion, wherein the knob frame moves in the first direction and the switch trigger component triggers the switch component.

In some embodiments, the knob frame further includes a partition disposed inside the gripping portion and separating an internal space of the gripping portion, wherein the clastic portion is formed on a side of the partition facing the support component.

In some embodiments, the elastic portion includes a plurality of elastic tabs extending outward from the side of the partition facing the support component, wherein the plurality of elastic tabs are distributed on the partition at equal intervals in a circumferential direction.

In some embodiments, the connecting portion includes a disc-shaped structure cooperating with the plurality of elastic tabs.

In some embodiments, the first circuit board component is fixed on the knob frame, the switch component is fixed on the first circuit board component, wherein the switch trigger component is formed on the support component and extends toward the switch component.

In some embodiments, the load control device further includes a second circuit board component electrically connected to the first circuit board component, located on a side of the support component away from the knob frame, wherein the switch component is fixed on a side of the second circuit board component facing the knob frame, and wherein the switch trigger component is formed on a side of the knob frame and extends toward the switch component.

In some embodiments, the load control device further includes a display assembly disposed on the knob frame, the display assembly including a display screen bracket and a display screen, the display screen being fixed on a side surface of the display screen bracket facing away from the support component.

In some embodiments, the first circuit board component is fixed on a side surface of the display screen bracket facing away from the display screen.

In some embodiments, the support component, the knob frame, the first circuit board component, the switch trigger component, the switch component, and the adjustment component form a knob assembly of a knob dimmer.

In another aspect, the present invention provides a load control device for regulating an electrical load, which includes: a support component, including a connection portion; a knob frame, including a gripping portion and an elastic portion, wherein the gripping portion at least partially surrounds the support component and is configured to rotate in response to a rotational force acting thereon thereby driving the knob frame to rotate, and wherein the elastic portion is configured to move toward the connecting portion in response to the knob frame moving toward a first direction, thereby undergoing elastic deformation; a first circuit board component; a switch trigger component; a switch component, coupled to the first circuit board component, configured to control the electrical load in response to triggering and releasing triggering by the switch trigger component; an adjustment component, coupled to the first circuit board component, configured to adjust the electrical load in response to the rotation of the knob frame; and a display assembly, coupled to the first circuit board component, disposed on the knob frame on a side surface facing away from the support component; wherein the knob frame is configured to move toward the first direction in response to a first force acting on it, to drive the switch trigger component to trigger the switch component; and in response to a second force acting on it, to move toward a second direction opposite to the first direction under action of the elastic portion moving away from the connection portion due to recovery from elastic deformation, whereby the switch trigger component releases the triggering of the switch component.

In some embodiments, the knob frame further includes a snap-fit portion, and the support component further includes a corresponding snap-fit portion, and wherein the snap-fit portion cooperates with the corresponding snap-fit portion to prevent the knob frame from falling off the support component during assembly of the knob frame to the support component.

In some embodiments, when the knob frame moves toward the first direction, the snap-fit portion moves away from the corresponding snap-fit portion, and when the knob frame moves toward the second direction, the snap-fit portion moves toward the corresponding snap-fit portion to engage with the corresponding snap-fit portion.

In some embodiments, the snap-fit portion is formed on an inner wall of the gripping portion, and the corresponding snap-fit portion is formed on an edge of the connection portion.

In some embodiments, the snap-fit portion includes a plurality of claws extending inward from the inner wall of the gripping portion, wherein the plurality of claws are circumferentially distributed at equal intervals on the inner wall of the gripping portion.

In some embodiments, the corresponding snap-fit portion includes a step portion formed at an edge of the connecting portion.

In some embodiments, when the first force is applied to the edge of the knob frame, at least one of the plurality of claws clamps the step portion, wherein the knob frame moves in the first direction and the switch trigger component triggers the switch component.

In some embodiments, the knob frame further includes a partition disposed inside the gripping portion and separating an internal space of the gripping portion, wherein the elastic portion is formed on a side of the partition facing the support component.

In some embodiments, the elastic portion includes a plurality of elastic tabs extending outward from the side of the partition facing the support component, wherein the plurality of elastic tabs are distributed on the partition at equal intervals in a circumferential direction.

In some embodiments, the connecting portion includes a disc-shaped structure cooperating with the plurality of elastic tabs.

In some embodiments, the first circuit board component is fixed on the knob frame, the switch component is fixed on the first circuit board component, wherein the switch trigger component is formed on the support component and extends toward the switch component.

In some embodiments, the load control device further includes a second circuit board component electrically connected to the first circuit board component, located on a side of the support component away from the knob frame, wherein the switch component is fixed on a side of the second circuit board component facing the knob frame, and wherein the switch trigger component is formed on a side of the knob frame and extends toward the switch component.

In some embodiments, the display assembly includes a display screen bracket and a display screen, the display screen being fixed on a side surface of the display screen bracket facing away from the support component.

In some embodiments, the first circuit board component is fixed on a side surface of the display screen bracket facing away from the display screen.

In some embodiments, the support component, the knob frame, the first circuit board component, the switch trigger component, the switch component, the adjustment component, and the display assembly form a knob assembly of a knob dimmer.

In another aspect, the present invention provides a load control system, including a load control device of any of the above embodiments.

In the load control device according to embodiments of the present invention, an elastic portion is provided on the knob frame and a connecting portion is provided on the support component. By applying a thrust force, for example, to the knob frame toward the support component, the elastic portion may be driven to move toward the connecting portion to undergo elastic deformation and trigger the switch component. After the applied force is cancelled, the elastic portion moves away from the connecting portion due to the recovery of elastic deformation, so that the knob frame moves away from the support component, thereby releasing the trigger switch component. Based on this, the load control device of embodiments of the present invention can simultaneously realize the rotation and pressing functions of the knob frame to better achieve load control.

### BRIEF DESCRIPTION OF DRAWINGS

Preferred embodiments of the present invention are described with reference to the drawings. These drawings explain the embodiments and their operating principle, and only illustrate structures that are necessary to the understanding of the invention. These drawings are not to scale. In the drawings, like features are designated by like reference symbols.

FIG. 1 schematically illustrates an exemplary knob-type dimmer according to an embodiment of the present invention.

FIG. 2 is an exploded view of the knob-type dimmer according to an embodiment of the present invention.

FIG. 3 schematically illustrates a support component according to an embodiment of the present invention.

FIG. 4 schematically illustrates an outer frame according to an embodiment of the present invention.

FIG. 5 is a side cross-sectional view along line A-A of FIG. 1 showing the knob-type dimmer when no force is exerted on it.

FIG. 6 is a side cross-sectional view showing the knob-type dimmer when a

force is exerted on its center part.

FIG. 7 is a side cross-sectional view showing the knob-type dimmer when a force is exerted on its peripheral part.

FIG. 8 is a side cross-sectional view of a knob-type dimmer according to another embodiment of the present invention when no force is exerted on it.

FIG. 9 schematically illustrates exemplary adjusting component and outer frame of the knob according to embodiments of the present invention.

FIG. 10 schematically illustrates exemplary first circuit board component, adjusting component and support member of the knob according to embodiments of the present invention.

### DETAILED DESCRIPTION OF THE INVENTION

The implementation and use of the embodiments are discussed in detail below. However, it should be understood that the specific embodiments discussed are merely exemplary of specific ways to implement and use the present invention, and are not intended to limit the scope of the present invention. When describing the structural positions of the various components, such as up, down, top, bottom, etc., the expressions of directions are not absolute, but relative. When the various components are arranged as shown in the figure, these directional expressions are appropriate, but when the positions of the various components in the figure change, these directional expressions also change accordingly.

Embodiments of the present invention provide a load control device and a load control system including the load control device. The load control device may be, for example, a knob assembly, which may be installed in a load control system such as a knob dimmer to control a lighting load. Alternatively, it may be installed in other load control systems such as electric fans, electric heaters, humidifiers, etc. to achieve load control.

Below, various embodiments of the present invention are described using a knob assembly as an example of a load control device and a knob-type dimmer equipped with the knob assembly as an example of a load control system. It should be noted that the various embodiments below are only exemplary, and the load control device of the present invention is not limited to the knob assembly, and the load control system is not limited to the knob-type dimmer.

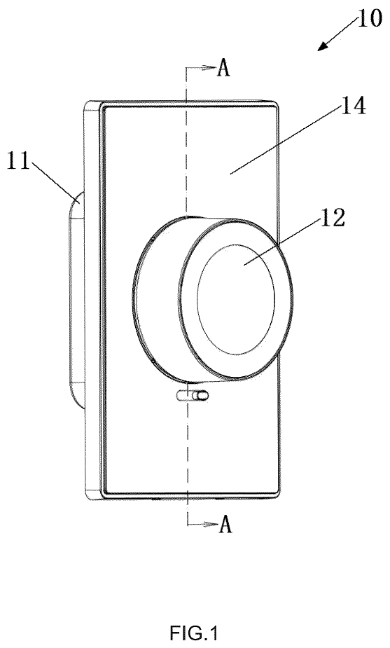

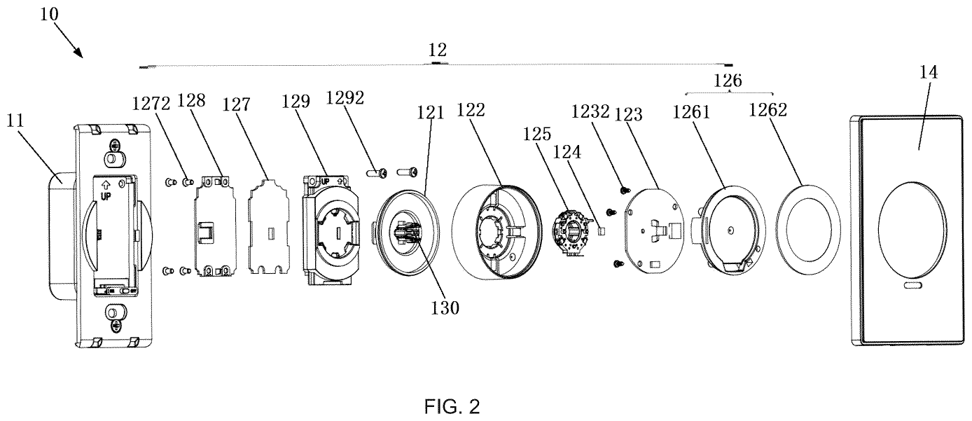

Referring to FIGS. 1 to 10, an exemplary knob-type dimmer 10 includes a housing 11 and a knob assembly 12. The housing 11 defines a receiving cavity for accommodating mechanical components and/or electronic components, such as a PCBA board, a micro switch, a trigger, etc. The knob assembly 12 is assembled to the housing 11. For example, the knob assembly 12 may be assembled to the side of the opening of the receiving cavity of the housing 11 to confine the mechanical and/or electronic components, etc., housed in the receiving cavity within the housing 11.

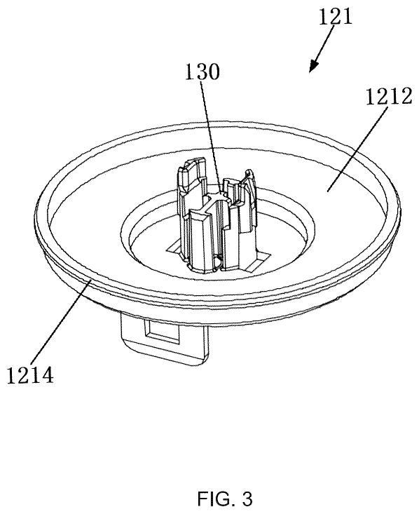

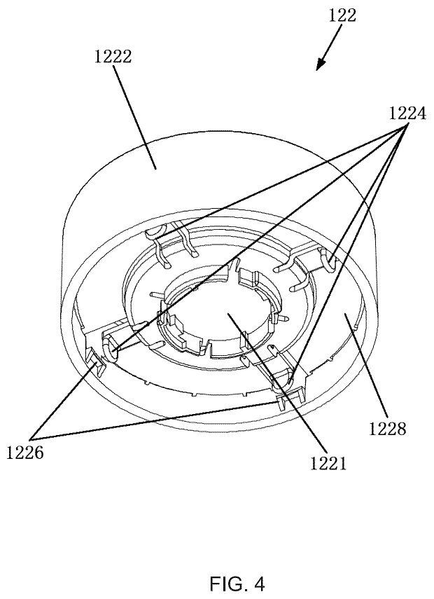

The knob assembly 12 may include a support component 121, a knob frame 122, a first circuit board component 123, a switch component 124, an adjustment component 125, and a switch trigger component 130. The support component 121 may include a connecting portion 1212, as shown in FIG. 3. The knob frame 122 may include a gripping portion 1222 and an elastic portion 1224, as shown in FIG. 4. When the knob frame 122 is assembled on the support component 121, the gripping portion 1222 of the knob frame 122 at least partially surrounds the support component 121, and the elastic portion 1224 of the knob frame 122 may contact the connecting portion 1212 of the support component 121. The knob frame 122 may receive a force applied by an operator to the knob frame 122 and perform an action in response thereto. The force applied by the operator to the knob frame 122 may be a variety of types of forces, such as a rotational force, a thrust force, a pulling force, or a pressing force. In addition, the force applied by the operator to the knob frame 122 may also act on multiple positions on the outer frame, for example, on the gripping portion 1222, or on the end of the outer frame away from the support component 121. Taking the operator applying force to the gripping portion 1222 of the knob frame 122 as an example, for example, by applying a rotational force to the gripping portion 1222, the knob frame 122 may be rotated. For another example, applying a thrust to the gripping portion 1222 toward the support component 121 may change the relative position of the knob frame 122 and the support component 121, so that the elastic portion 1224 moves toward the connecting portion 1212. Taking the operator applying a force to the end of the knob frame 122 away from the support component 121 as an example, for example, by applying a thrust to that end toward the support component 121, the relative position of the knob frame 122 and the support component 121 may be changed, so that the clastic portion 1224 moves toward the connecting portion 1212. When the elastic portion 1224 moves toward the connecting portion 1212, the clastic portion 1224 squeezes the connecting portion 1212, causing an clastic deformation. When the applied thrust is maintained, the elastic deformation will be maintained. When the applied thrust is released or reduced to a level sufficient for the clastic portion 1224 to recover from the elastic deformation, the elastic portion 1224 moves in a direction away from the connecting portion 1212, that is, the elastic portion 1224 moves away from the connecting portion 1212. It may be understood that the positions where the operator applies force to the knob frame 122 described above are only exemplary and not limiting.

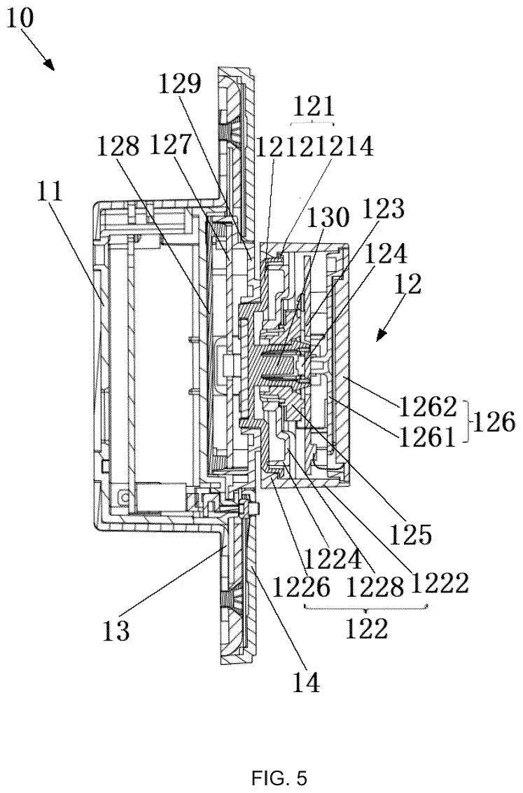

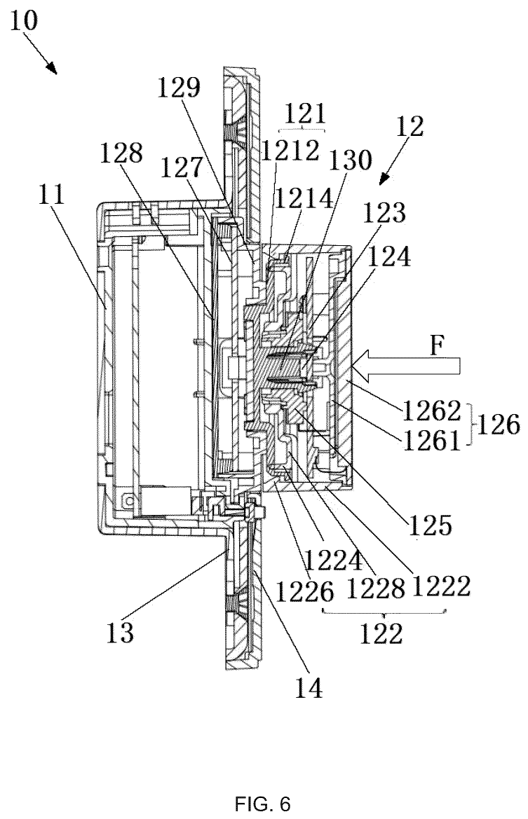

In some embodiments, the knob frame 122 may further include a snap-fit portion 1226. Accordingly, the support component 121 may further include a corresponding snap-fit portion 1214. When the knob frame 122 is assembled to the support component 121, the snap-fit portion 1226 cooperates with the corresponding snap-fit portion 1214 to prevent the knob frame 122 from falling off the support component 121, as shown in FIG. 5. When a force is applied to the knob frame 122, in response to the applied force, the knob frame 122 moves toward the support component 121, driving the snap-fit portion 1226 to move away from the corresponding snap-fit portion 1214, so that the snap-fit portion 1226 and the corresponding snap-fit portion 1214 no longer form a snap connection, as shown in FIG. 6. When the force applied to the knob frame 122 is removed, the knob frame 122 moves away from the support component 121, driving the snap-fit portion 1226 to move toward the corresponding snap-fit portion 1214, thereby snap-fitting with the corresponding snap-fit portion 1214 again, as shown in FIG. 5.

The first circuit board component 123 is located in the knob assembly 12, and multiple functional modules may be integrated thereon to achieve multiple required functions. The first circuit board component 123 may include a whole PCBA (Printed Circuit Board Assembly) board, or multiple separate PCBA boards.

The switch component 124 is coupled to the first circuit board component 123. By triggering and releasing the switch component 124 by the switch trigger component 130, the lighting load may be controlled. For example, by triggering the switch component 124 by the switch trigger component 130, the lighting load may be controlled to turn on. By triggering the switch component 124 again by the switch trigger component 130, the lighting load may be controlled to turn off. The switch component 124 may be, for example, a patch switch, or other suitable types of switch elements. The switch component 124 may be disposed at any suitable position in the knob assembly 12. Similarly, the switch trigger component 130 may be disposed at any suitable position in the knob assembly 12 suitable for triggering/releasing the trigger to the switch component 124. This will be described in detail below.

The adjustment component 125 is coupled to the first circuit board component 123. By operating the adjustment component 125, the lighting load may be adjusted. In some embodiments, the adjustment component 125 may be a dimming component, such as a dimming encoder. For example, by turning the dimming encoder, the brightness, color temperature, color, etc. of the lighting load may be adjusted.

The “coupling” mentioned above refers to the switch component 124 and the adjustment component 125 being electrically connected to the first circuit board component 123 directly or indirectly through other electronic components.

When installing the knob dimmer 10, the housing 11 may be first installed at a desired position, such as a wall box on a wall. The housing 11 may be fixed to the desired position by screw connection or other suitable methods. In some embodiments, a mounting bracket 13 may also be provided on the housing 11. The mounting bracket 13 may be fixed to the housing 11 by snap connection or other suitable methods. The housing 11 may be installed to the desired position by the mounting bracket 13. Then, the knob assembly 12 is assembled to the housing 11, and the first circuit board component 123 in the knob assembly 12 is electrically connected to other circuit board components in the housing 11.

In some embodiments, in order to protect and/or decorate the dimmer, the knob-type dimmer 10 may further include a panel 14 on which an opening is formed. During installation, for example, the knob assembly 12 may be assembled to the housing 11 first, and then the panel 14 may be installed to the housing 11 so that the knob frame 122 of the knob assembly 12 extends out of the opening of the panel 14. For another example, considering the difference in matching degree between the opening size on the panel 14 and the knob frame 122, the panel 14 may be installed to the housing 11 first, and then the knob assembly 12 may be installed.

After installation, the knob dimmer 10 is coupled with the power supply end and the lighting load respectively. In operation, by applying a first force on the knob frame 122, the knob frame 122 may move toward a first direction, for example, toward the support component 121, so that the switch trigger component 130 triggers the switch component 124, thereby realizing the control of the lighting load, for example, the lighting load may be controlled to turn on. At the same time, in response to the movement of the knob frame 122 toward the first direction, the elastic portion 1224 may move toward the connecting portion 1212 and presses the connecting portion 1212, thereby causing elastically deformation. Subsequently, a second force may be applied to the knob frame 122, and the second force may be a force less than the rebound force generated by the elastic portion 1224 due to the recovery of the elastic deformation, so that the elastic portion 1224 may recover the elastic deformation, or the second force may also be a force of approximately zero, that is, the first force applied to the knob frame 122 is approximately cancelled. In response to the second force, the elastic portion 1224 recovers its elastic deformation and moves away from the connecting portion 1212, and the knob frame 122 moves in a second direction opposite to the first direction, for example, moves away from the supporting component 121, so that the switch trigger component 130 releases the trigger switch component 124.

By applying the first force again on the knob frame 122, the switch component 124 may be triggered again, thereby achieving another control of the lighting load, for example, controlling the lighting load to be turned off.

In addition, by applying a rotational force to the knob frame 122, the knob frame 122 may rotate, so that the adjustment component 125 is actuated, thereby adjusting the lighting load. For example, the brightness, color temperature, color, etc. of the lighting load may be adjusted.

It is understandable that the rotational force and the first force (second force) applied to the knob frame 122 may act on the knob frame 122 separately, for example, the first force (second force) is applied first, and then the rotational force is applied, or vice versa. Alternatively, they may also act on the knob frame 122 at the same time, for example, the first force (second force) is applied while the rotational force is applied, so as to achieve the adjustment and control of the lighting load.

The knob frame 122 may have different shapes and structures in different embodiments. For example, the knob frame 122 may be cylindrical, prism-shaped or other suitable shapes. Taking the knob frame 122 as a cylinder as an example, it may be a hollow structure with one end closed and the other end open. The open end may be mounted to the support component 121. For the knob frame of this structure, it may be understood that the force applied to it may act on the outer wall of the cylinder or the closed end of the cylinder. The force applied to the closed end may, for example, act on its central area or on its edge area.

In some embodiments, the knob frame 122 may further include a partition 1228, which may be disposed inside the gripping portion 1222 and separate the internal space of the gripping portion 1222. For example, the partition 1228 may separate the internal space of the gripping portion 1222 into a first area and a second area. Some components in the knob assembly 12, such as the support component 121, etc., may be mainly located in the first area, and other components in the knob assembly 12, such as the adjustment component 125, the first circuit board component 123, etc., may be mainly located in the second area. When assembling the knob frame 122 and the support component 121, the knob frame 122 may be mounted on the support component 121 so that the opening side of the first area is adjacent to the support component 121. In other words, the support component 121 may be located on the opening side of the first area formed by the partition 1228.

In some embodiments, the elastic portion 1224 of the knob frame 122 may be formed on the side of the partition 1228 facing the support component 121. The elastic portion 1224 may be any suitable structure with elastic structure and function. For example, it may be a plurality of elastic tabs extending outward from the side of the partition 1228 facing the support component 121, as shown in FIG. 4. The plurality of clastic tabs may be distributed on the partition 1228 at equal intervals in the circumferential direction, so that after assembly, the plurality of clastic tabs may act on the connecting portion 1212 of the support component 121 in an evenly distributed manner, so that the entire knob assembly 12 is assembled smoothly and not easy to shake. The plurality of elastic tabs may be made of, for example, metal spring plates and fixed on the partition 1228.

In some embodiments, the connecting portion 1212 of the support component 121 may be a disc-shaped structure cooperating with the plurality of elastic tabs, such as a circular disc-shaped structure, as shown in FIG. 3.

In some embodiments, the snap-fit portion 1226 of the knob frame 122 may be formed on the inner wall of the gripping portion 1222. The snap-fit portion 1226 may have any suitable shape and structure, for example, the snap-fit portion 1226 may be a plurality of claws extending inward from the inner wall of the gripping portion 1222, as shown in FIG. 4. The plurality of claws may be circumferentially distributed at equal intervals on the inner wall of the gripping portion 1222, so that the knob frame 122 is not easy to fall off, which improves reliability.

In some embodiments, the corresponding snap-fit portion 1214 may be formed at an edge of the connecting portion 1212. For example, the corresponding snap-fit portion 1214 may be a step portion formed at an edge of the connecting portion 1212 (e.g. a circular lip or flange), as shown in FIG. 3.

In some embodiments, the knob assembly 12 may further include a display assembly 126, which is disposed on the knob frame 122. For example, the display assembly 126 may be installed on the opening side of the second area separated by the partition 1228 of the knob frame 122. Since the display assembly 126 is installed on the knob frame 122 and exposed to the outside, the operator may apply force to the display assembly 126, and the applied force in turn acts on the knob frame 122 to cause it to move toward the first direction.

In some embodiments, the display screen assembly 126 may include a display screen bracket 1261 and a display screen 1262 fixed on a side surface of the display screen bracket 1261 facing away from the support component 121. The display screen 1262 may be electrically connected to the first circuit board component 123. The display screen 1262 and the display screen bracket 1261 may be fixed together in a variety of ways, for example, by sticking them together with adhesive. The display screen 1262 may display parameters and information related to the regulation of the lighting load, for example, the current color temperature, etc.

In some embodiments, the knob assembly 12 may further include a second circuit board component 127, which is electrically connected to the first circuit board component 123 in the knob assembly 12 and to other circuit boards in the housing 11. The second circuit board component 127 may be located on a side of the support component 121 away from the knob frame 122. For example, an LED light source may be provided on the second circuit board component 127, which may be used to illuminate the knob frame 122. In some embodiments, the knob assembly 12 may further include a circuit board bracket 128, which is used to support the second circuit board component 127.

In some embodiments, the knob assembly 12 may further include a cover plate 129. When assembling the components in the knob assembly 12, the circuit board bracket 128 and the second circuit board component 127 may be fixed to the first side of the cover plate 129 by, for example, screws 1272. The supporting component 121, the knob frame 122, the adjusting component 125 and other components may be sequentially installed on the second side of the cover plate 129 opposite to the first side. When the knob assembly 12 is installed on the housing 11, the cover plate 129 may be fixed to the opening side of the housing 11 by, for example, screws 1292 and/or a buckle structure on the cover plate 129, so that the knob assembly 12 is installed on the housing 11.

When the knob frame 122 is mounted on the support component 121, as described above, the plurality of claws on the knob frame 122 may be clamped on the step portion on the support component 121.

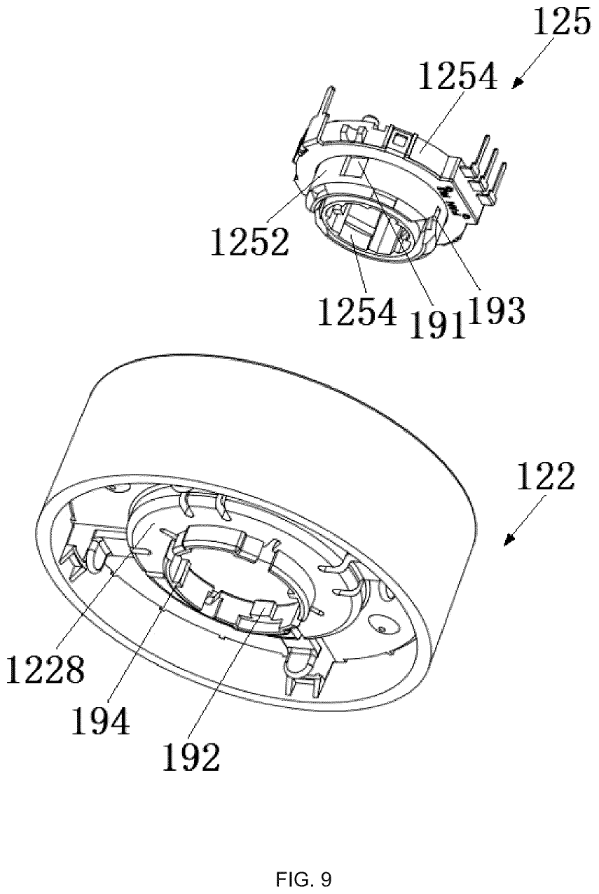

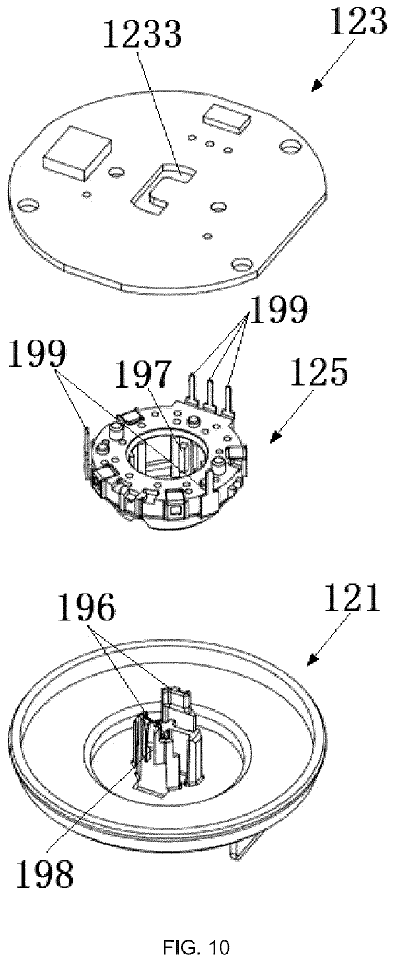

After the knob frame 122 is mounted on the support component 121, the adjustment component 125 may be installed next. Taking the adjustment component 125 as a central air dimming encoder as an example, as shown in FIGS. 9 and 10, the outer ring component 1252 of the dimming encoder may be mounted on the knob frame 122, such that the outer ring component 1252 may rotate with the rotation of the knob frame 122. For example, the wall extending outward from the central area of the partition 1228 and defining the through hole 1221 may include at least one protruding block 192 and/or at least one protruding strip 194, and correspondingly, the outer wall of the outer ring component 1252 may be formed with at least one recess 191 corresponding to the at least one protruding block 192 and/or at least one notch 193 corresponding to the at least one protruding strip 194. By matching the protruding block 192 with the recess 191 and the protruding strip 194 with the notch 193, the outer ring assembly 1252 of the dimming encoder may be fixed to the knob frame 122. In addition, the inner ring assembly 1254 of the dimming encoder may be mounted on the support component 121. For example, the support component 121 may also include a mounting member 196 extending outward from the central area thereof, and at least one position limiting groove 198 may be formed on the outer wall of the mounting member 196. Correspondingly, at least one sliding bar 197 corresponding to the at least one position limiting groove 198 may be formed on the inner ring assembly 1254. By matching the sliding bar 197 with the limiting sliding groove 198, the inner ring assembly 1254 of the dimming encoder may be movably mounted on the support component 121. As the sliding bar 197 slides in the position limiting groove 198, the dimming encoder may move axially along the outer wall of the mounting member 196. When the dimming encoder moves to a certain position in a direction away from the supporting component 121, the position limiting groove 198 blocks the sliding bar 197 so that the dimming encoder cannot continue to move in this direction.

The pins 199 on the inner ring component 1254 of the dimming encoder may be soldered to the first circuit board component 123 to form an electrical connection therewith. The first circuit board component 123 may also be formed with an opening 1233 for the top of the mounting member 196 on the support component 121 to extend therefrom. The first circuit board component 123 may also be fixed to the display assembly 126 by, for example, screws 1232. The display assembly 126 is arranged on the knob frame 122. When the knob frame 122 rotates, the display assembly 126 may be kept from rotating with the rotation of the knob frame 122. It is understood that in an embodiment that does not include the display assembly 126, the first circuit board component 123 may be fixed to the knob frame 122.

In some embodiments, as shown in FIGS. 5-7, the switch component 124 may be fixed on a side of the first circuit board component 123 facing the support component 121. The switch trigger component 130 may be formed on the support component 121, for example, it may be a protrusion extending from the central area of the support component 121 toward the switch component 124, as shown in FIG. 3.

When a first force is applied to the display screen 1262, in response to the first force, the display screen 1262 and the display screen bracket 1261 move toward a first direction, for example, toward the direction of the support component 121, so as to drive the first circuit board component 123 and the switch component 124 thereon to move toward the switch trigger component 130 formed on the support component 121, so that the switch trigger component 130 triggers the switch component 124. At the same time, the display screen 1262 and the display screen bracket 1261 drive the first circuit board component 123, the adjustment component 125 and the knob frame 122 to move toward the support component 121, so that the elastic portion 1224 moves toward the connecting portion 1212 and is pressed against the connecting portion 1212, thereby causing elastic deformation. Subsequently, when a second force is applied to the display screen 1262, in response to the second force, the elastic portion 1224 recovers from clastic deformation and moves away from the coupling portion 1212, and drives the adjustment component 125, the first circuit board component 123, the display screen bracket 1261 and the knob frame 122 to move together in a second direction opposite to the first direction, for example, in a direction away from the supporting component 121, so that the switch component 124 moves away from the switch trigger component 130 formed on the supporting component 121, so that the switch trigger component 130 releases the triggering switch component 124.

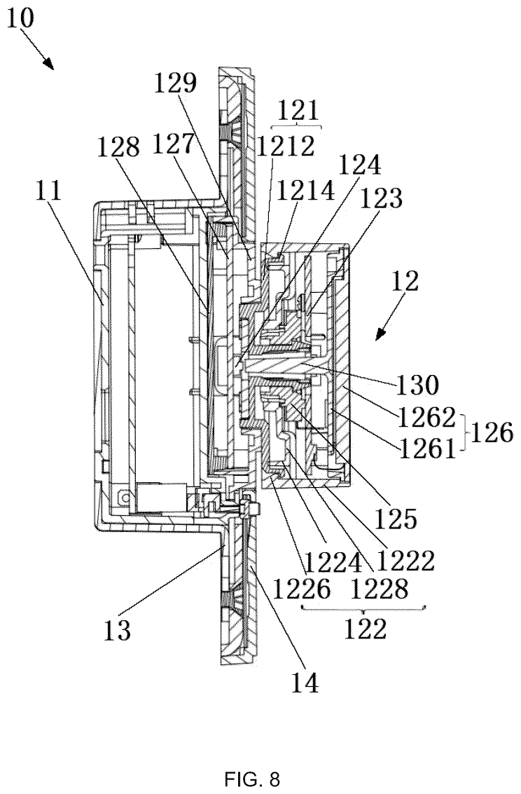

In other embodiments, as shown in FIG. 8, the switch component 124 may be fixed on a side of the second circuit board component 127 facing the display bracket 1261. The switch trigger component 130 may be formed on a side of the display bracket 1261 facing the second circuit board component 127 and extend toward the switch component 124. The switch trigger component 130 may extend through the first circuit board component 123, the adjustment component 125, the partition 1228 of the knob frame 122, the support component 121, and the cover plate 129.

When the first force is applied to the display screen 1262, in response to the first force, the display screen 1262 and the display screen bracket 1261 move toward a first direction, for example, toward the direction of the support component 121, so as to drive the switch trigger component 130 to move toward the switch component 124 on the second circuit board component 127, so that the switch trigger component 130 triggers the switch component 124. At the same time, the display screen 1262 and the display screen bracket 1261 drive the first circuit board component 123, the adjustment component 125 and the knob frame 122 to move toward the support component 121, so that the elastic portion 1224 moves toward the connecting portion 1212 and is pressed against the connecting portion 1212, thereby causing elastic deformation. Subsequently, when a second force is applied to the display screen 1262, in response to the second force, the elastic portion 1224 recovers from elastic deformation and moves away from the connecting portion 1212, and drives the adjusting component 125, the first circuit board component 123, the display screen bracket 1261 and the knob frame 122 to move together in a second direction opposite to the first direction, for example, away from the supporting component 121, so that the switch trigger component 130 moves away from the switch component 124, thereby the switch trigger component 130 releases the triggering of the switch component 124.

In some embodiments, the force applied to the display screen 1262, such as the first force and the second force, may be applied to a middle position of the display screen 1262, as shown in FIG. 6.

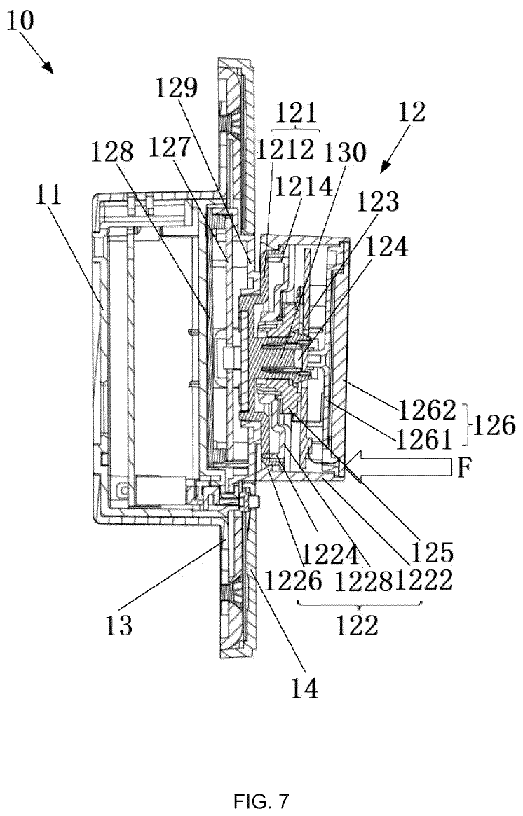

In other embodiments, the forces applied to the display screen 1262, such as the first force and the second force, may act on the edge of the display screen 1262, as shown in FIG. 7. The edge may be the edge of the display screen 1262, or the junction of the display screen 1262 and the knob frame 122. When the two forces are applied to the edge, at least one of the multiple claws on the knob frame 122 located on the side opposite to the edge will clamp the step portion on the support component 121 to prevent the knob frame 122 on that side from falling out, so that the display screen assembly 126 and the knob frame 122 may still move in the first direction, so that the switch trigger component 130 triggers the switch component 124.

The knob-type dimmers of the various embodiments of the present invention may be applied to various occasions where the load illumination needs to be adjusted, such as residential buildings, office buildings, shopping malls or other places.

It should be understood that the embodiments shown in FIGS. 1 to 10 only illustrate the main implementation units or components of the knob-type dimmer according to embodiments of the present invention, and the shape and arrangement of each unit or component are only for illustration and not limiting. Without departing from the spirit and scope of the present invention, the units or components in the knob-type dimmer may have other shapes and sizes.

It will be apparent to those skilled in the art that various modification and variations may be made in the embodiments of the present invention without departing from the spirit or scope of the invention. Thus, it is intended that the present invention cover modifications and variations that come within the scope of the appended claims and their equivalents.

1. A load control device for regulating an electrical load, comprising:
a support component, including a connection portion;
a knob frame, including a gripping portion and an elastic portion, wherein the gripping portion at least partially surrounds the support component and is configured to rotate in response to a rotational force acting thereon thereby driving the knob frame to rotate, and wherein the elastic portion is configured to move toward the connecting portion in response to the knob frame moving toward a first direction, thereby undergoing elastic deformation;
a first circuit board component;
a switch trigger component;
a switch component, coupled to the first circuit board component, configured to control the electrical load in response to triggering and releasing triggering by the switch trigger component; and
an adjustment component, coupled to the first circuit board component, configured to adjust the electrical load in response to the rotation of the knob frame;
wherein the knob frame is configured to move toward the first direction in response to a first force acting on it, to drive the switch trigger component to trigger the switch component; and in response to a second force acting on it, to move toward a second direction opposite to the first direction under action of the elastic portion moving away from the connection portion due to recovery from elastic deformation, whereby the switch trigger component releases the triggering of the switch component.

2. The load control device of claim 1, wherein the knob frame further includes a snap-fit portion, and the support component further includes a corresponding snap-fit portion, and wherein the snap-fit portion cooperates with the corresponding snap-fit portion to prevent the knob frame from falling off the support component during assembly of the knob frame to the support component.

3. The load control device of claim 2, wherein when the knob frame moves toward the first direction, the snap-fit portion moves away from the corresponding snap-fit portion, and when the knob frame moves toward the second direction, the snap-fit portion moves toward the corresponding snap-fit portion to engage with the corresponding snap-fit portion.

4. The load control device of claim 3, wherein the snap-fit portion is formed on an inner wall of the gripping portion, and the corresponding snap-fit portion is formed on an edge of the connection portion.

5. The load control device of claim 4, wherein the snap-fit portion includes a plurality of claws extending inward from the inner wall of the gripping portion, wherein the plurality of claws are circumferentially distributed at equal intervals on the inner wall of the gripping portion.

6. The load control device of claim 5, wherein the corresponding snap-fit portion includes a step portion formed at an edge of the connecting portion.

7. The load control device of claim 6, wherein when the first force is applied to the edge of the knob frame, at least one of the plurality of claws clamps the step portion, wherein the knob frame moves in the first direction and the switch trigger component triggers the switch component.

8. The load control device of claim 1, wherein the knob frame further includes a partition disposed inside the gripping portion and separating an internal space of the gripping portion, wherein the elastic portion is formed on a side of the partition facing the support component.

9. The load control device of claim 8, wherein the elastic portion includes a plurality of elastic tabs extending outward from the side of the partition facing the support component, wherein the plurality of elastic tabs are distributed on the partition at equal intervals in a circumferential direction.

10. The load control device of claim 9, wherein the connecting portion includes a disc-shaped structure cooperating with the plurality of elastic tabs.

11. The load control device of claim 1, further comprising a second circuit board component electrically connected to the first circuit board component, located on a side of the support component away from the knob frame, wherein the switch component is fixed on a side of the second circuit board component facing the knob frame, and wherein the switch trigger component is formed on a side of the knob frame and extends toward the switch component.

12. The load control device of claim 1, further comprising a display assembly disposed on the knob frame, the display assembly including a display screen bracket and a display screen, the display screen being fixed on a side surface of the display screen bracket facing away from the support component.

13. The load control device of claim 1, wherein the first circuit board component is fixed on a side surface of the display screen bracket facing away from the display screen.

14. The load control device of claim 1, wherein the support component, the knob frame, the first circuit board component, the switch trigger component, the switch component, and the adjustment component form a knob assembly of a knob dimmer.

15. A load control device for regulating an electrical load, comprising:
a support component, including a connection portion;
a knob frame, including a gripping portion and an elastic portion, wherein the gripping portion at least partially surrounds the support component and is configured to rotate in response to a rotational force acting thereon thereby driving the knob frame to rotate, and wherein the elastic portion is configured to move toward the connecting portion in response to the knob frame moving toward a first direction, thereby undergoing elastic deformation;
a first circuit board component;
a switch trigger component;
a switch component, coupled to the first circuit board component, configured to control the electrical load in response to triggering and releasing triggering by the switch trigger component;
an adjustment component, coupled to the first circuit board component, configured to adjust the electrical load in response to the rotation of the knob frame; and
a display assembly, coupled to the first circuit board component, disposed on the knob frame on a side surface facing away from the support component;
wherein the knob frame is configured to move toward the first direction in response to a first force acting on it, to drive the switch trigger component to trigger the switch component;
and in response to a second force acting on it, to move toward a second direction opposite to the first direction under action of the elastic portion moving away from the connection portion due to recovery from elastic deformation, whereby the switch trigger component releases the triggering of the switch component.

16. The load control device of claim 15, wherein the knob frame further includes a snap-fit portion, and the support component further includes a corresponding snap-fit portion, and wherein the snap-fit portion cooperates with the corresponding snap-fit portion to prevent the knob frame from falling off the support component during assembly of the knob frame to the support component.

17. The load control device of claim 16, wherein when the knob frame moves toward the first direction, the snap-fit portion moves away from the corresponding snap-fit portion, and when the knob frame moves toward the second direction, the snap-fit portion moves toward the corresponding snap-fit portion to engage with the corresponding snap-fit portion.

18. The load control device of claim 17, wherein the snap-fit portion is formed on an inner wall of the gripping portion, and the corresponding snap-fit portion is formed on an edge of the connection portion.

19. The load control device of claim 18, wherein the snap-fit portion includes a plurality of claws extending inward from the inner wall of the gripping portion, wherein the plurality of claws are circumferentially distributed at equal intervals on the inner wall of the gripping portion.

20. The load control device of claim 19, wherein the corresponding snap-fit portion includes a step portion formed at an edge of the connecting portion.

21. The load control device of claim 20, wherein when the first force is applied to the edge of the knob frame, at least one of the plurality of claws clamps the step portion, wherein the knob frame moves in the first direction and the switch trigger component triggers the switch component.

22. The load control device of claim 15, wherein the knob frame further includes a partition disposed inside the gripping portion and separating an internal space of the gripping portion, wherein the elastic portion is formed on a side of the partition facing the support component.

23. The load control device of claim 22, wherein the elastic portion includes a plurality of elastic tabs extending outward from the side of the partition facing the support component, wherein the plurality of elastic tabs are distributed on the partition at equal intervals in a circumferential direction.

24. The load control device of claim 23, wherein the connecting portion includes a disc-shaped structure cooperating with the plurality of elastic tabs.

25. The load control device of claim 15, further comprising a second circuit board component electrically connected to the first circuit board component, located on a side of the support component away from the knob frame, wherein the switch component is fixed on a side of the second circuit board component facing the knob frame, and wherein the switch trigger component is formed on a side of the knob frame and extends toward the switch component.

26. The load control device of claim 15, wherein the display assembly includes a display screen bracket and a display screen, the display screen being fixed on a side surface of the display screen bracket facing away from the support component.

27. The load control device of claim 26, wherein the first circuit board component is fixed on a side surface of the display screen bracket facing away from the display screen.

28. The load control device of claim 16, wherein the support component, the knob frame, the first circuit board component, the switch trigger component, the switch component, the adjustment component, and the display assembly form a knob assembly of a knob dimmer.

29. A load control system, including a load control device of claim 1.

30. A load control system, including a load control device of claim 15.
